(19) United States
(12) Patent Application Publication
(10) Pub. No.: US 2025/0175295 A1
(43) Pub. Date: May 29, 2025

(54) REFERENCE SIGNAL DATA COLLECTION FOR TRAINING MACHINE LEARNING MODELS

(71) Applicant: QUALCOMM Incorporated, San Diego, CA (US)

(72) Inventors: Chenxi HAO, Beijing (CN); Runxin WANG, San Diego, CA (US); Yu ZHANG, San Diego, CA (US); Taesang YOO, San Diego, CA (US); June NAMGOONG, San Diego, CA (US); Pavan Kumar VITTHALADEVUNI, San Diego, CA (US); Jay Kumar SUNDARARAJAN, San Diego, CA (US); Naga BHUSHAN, San Diego, CA (US); Krishna Kiran MUKKAVILLI, San Diego, CA (US); Tingfang JI, San Diego, CA (US); Xipeng ZHU, San Diego, CA (US)

(21) Appl. No.: 18/841,774

(22) PCT Filed: Apr. 29, 2022
(86) PCT No.: PCT/CN2022/090539

§ 371 Date: Aug. 27, 2024

(51) Int. Cl. H04L 5/00; H04L 25/02; H04L 27/26

(52) U.S. Cl. CPC H04L 5/0048; H04L 25/0202; H04L 27/261

(57) ABSTRACT

Various aspects of the present disclosure generally relate to wireless communication. In some aspects, a user equipment (UE) may receive a configuration for a reference signal used for data collection and/or a first message that indicates that data collection based on the reference signal is allowed. The UE may receive the reference signal. The UE may collect data based at least in part on the reference signal. The UE may transmit the data that is collected. Numerous other aspects are described.

### FIELD OF THE DISCLOSURE

Aspects of the present disclosure generally relate to wireless communication and to techniques and apparatuses for collecting data for training machine learning models.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration for a reference signal used for data collection and/or a first message that indicates that data collection based on the reference signal is allowed. The method may include receiving the reference signal. The method may include collecting data based at least in part on the reference signal. The method may include transmitting the data that is collected.

Some aspects described herein relate to a method of wireless communication performed by a network entity. The method may include transmitting a configuration for a reference signal used for data collection and/or a first message that indicates that data collection based on the reference signal is allowed. The method may include transmitting the reference signal.

Some aspects described herein relate to a UE for wireless communication. The UE may include a memory and one or more processors coupled to the memory. The one or more processors may be configured to receive a configuration for a reference signal used for data collection and/or a first message that indicates that data collection based on the reference signal is allowed. The one or more processors may be configured to receive the reference signal. The one or more processors may be configured to collect data based at least in part on the reference signal. The one or more processors may be configured to transmit the data that is collected.

Some aspects described herein relate to a network entity for wireless communication. The network entity may include a memory and one or more processors coupled to the memory. The one or more processors may be configured to transmit a configuration for a reference signal used for data collection and/or a first message that indicates that data collection based on the reference signal is allowed. The one or more processors may be configured to transmit the reference signal.

Some aspects described herein relate to a non-transitory computer-readable medium that stores a set of instructions for wireless communication by a UE. The set of instructions, when executed by one or more processors of the UE, may cause the UE to receive a configuration for a reference signal used for data collection and/or a first message that indicates that data collection based on the reference signal is allowed. The set of instructions, when executed by one or more processors of the UE, may cause the UE to receive the reference signal. The set of instructions, when executed by one or more processors of the UE, may cause the UE to collect data based at least in part on the reference signal. The set of instructions, when executed by one or more processors of the UE, may cause the UE to transmit the data that is collected.

Some aspects described herein relate to a non-transitory computer-readable medium that stores a set of instructions for wireless communication by a network entity. The set of instructions, when executed by one or more processors of the network entity, may cause the network entity to transmit a configuration for a reference signal used for data collection and/or a first message that indicates that data collection based on the reference signal is allowed. The set of instructions, when executed by one or more processors of the network entity, may cause the network entity to transmit the reference signal.

Some aspects described herein relate to an apparatus for wireless communication. The apparatus may include means for receiving a configuration for a reference signal used for data collection and/or a first message that indicates that data collection based on the reference signal is allowed. The apparatus may include means for receiving the reference signal. The apparatus may include means for collecting data based at least in part on the reference signal. The apparatus may include means for transmitting the data that is collected.

Some aspects described herein relate to an apparatus for wireless communication. The apparatus may include means for transmitting a configuration for a reference signal used for data collection and/or a first message that indicates that data collection based on the reference signal is allowed. The apparatus may include means for transmitting the reference signal.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating examples of channel state information reference signal beam management procedures, in accordance with the present disclosure.

FIG. 5 is a diagram illustrating an example associated with collecting data for training machine learning models, in accordance with the present disclosure.

FIG. 6 is a diagram illustrating examples of collecting data for training machine learning models, in accordance with the present disclosure.

FIG. 7 is a diagram illustrating an example process performed, for example, by a UE, in accordance with the present disclosure.

FIG. 8 is a diagram illustrating an example process performed, for example, by a network entity, in accordance with the present disclosure.

FIGS. 9-10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

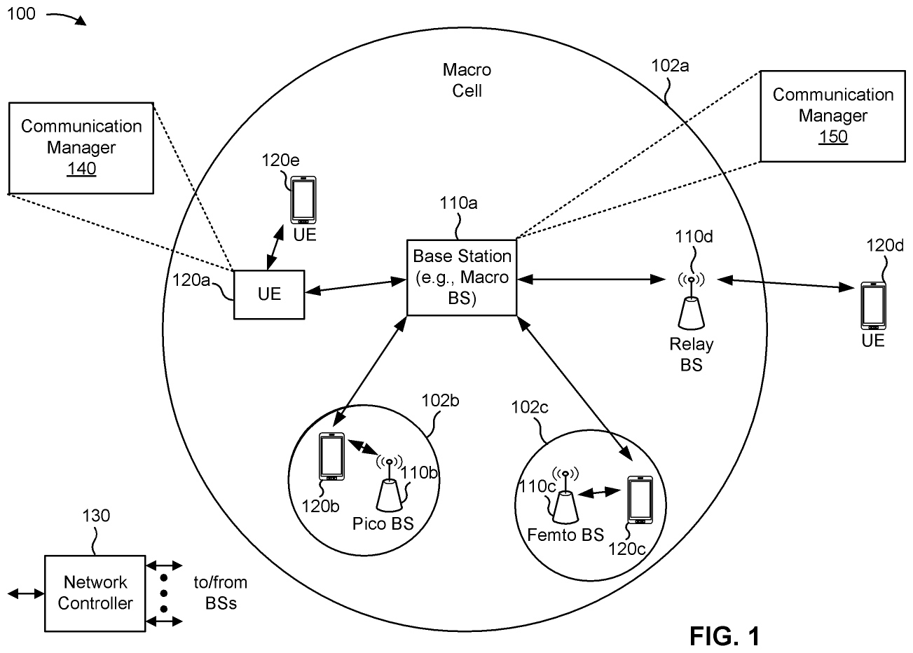

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHz). It should be understood that although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FRI characteristics and/or FR2 characteristics, and thus may effectively extend features of FRI and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive a configuration for a reference signal used for data collection and/or a first message that indicates that data collection based on the reference signal is allowed. The communication manager 140 may receive the reference signal and collect data based at least in part on the reference signal. The communication manager 140 may transmit the data that is collected. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit a configuration for a reference signal used for data collection and/or a first message that indicates that data collection based on the reference signal is allowed. The communication manager 150 may transmit the reference signal. Additionally, or alternatively, the communication manager 150 may perform one or more other operations described herein.

As indicated above, FIG. 1 is provided as an example. Other examples may differ from what is described with regard to FIG. 1.

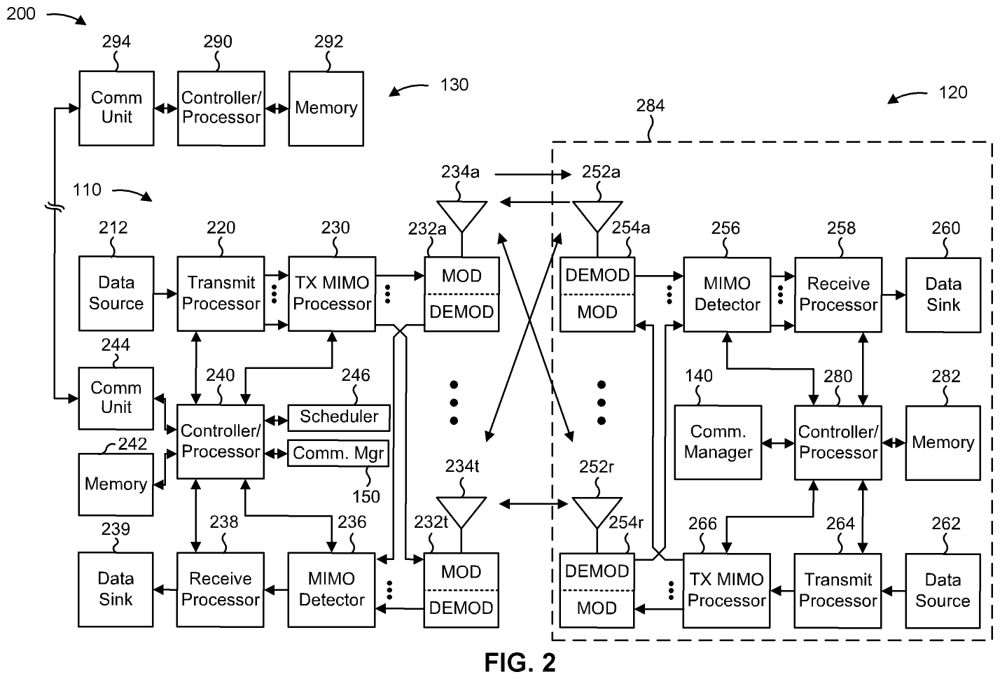

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

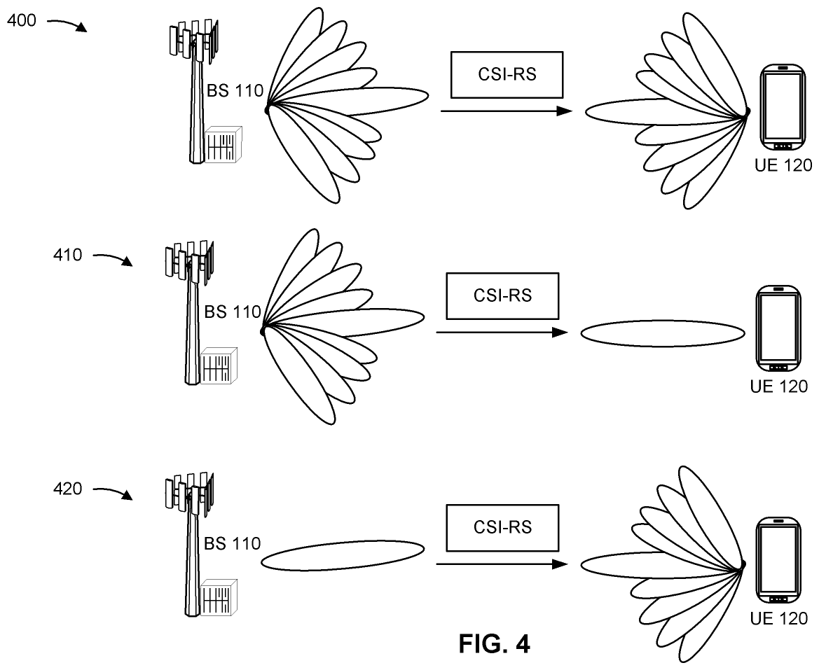

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

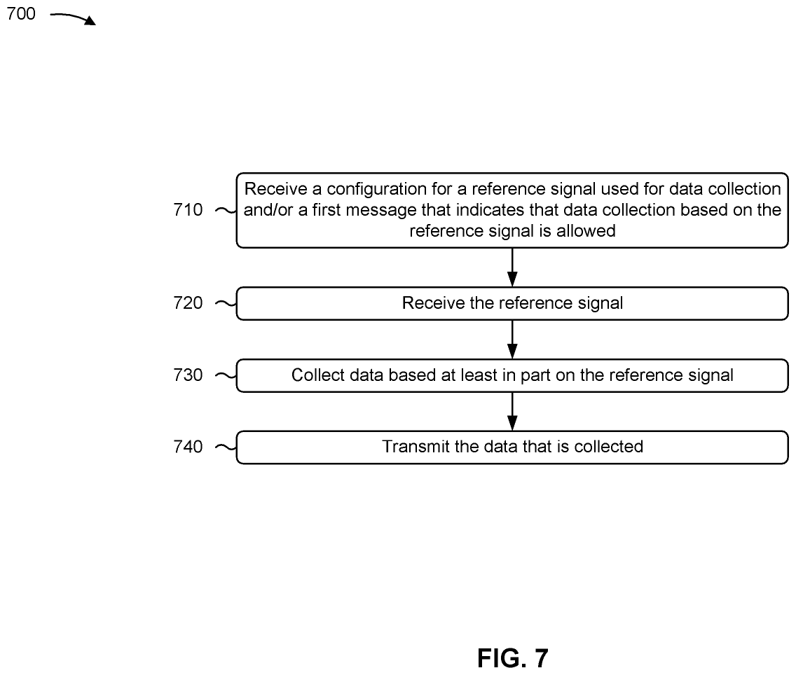

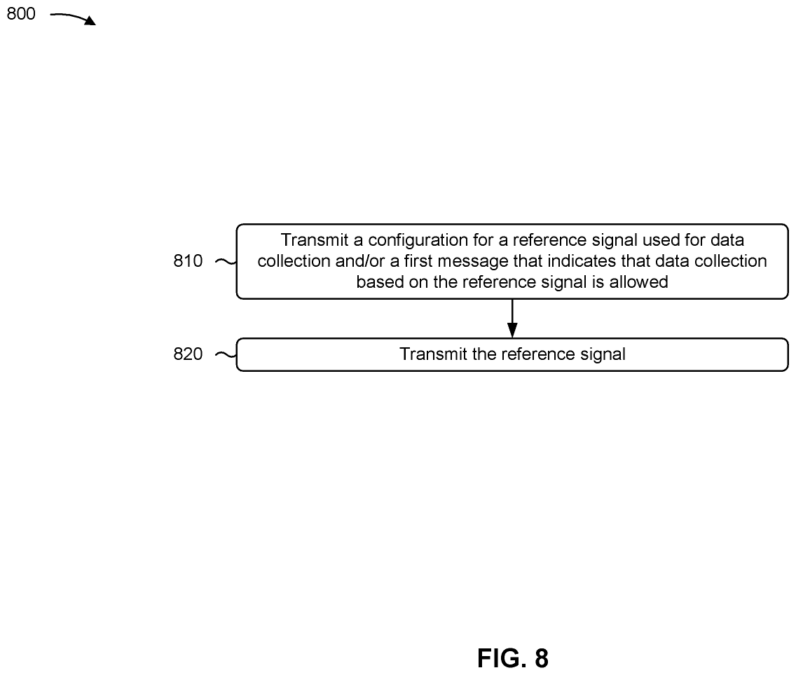

A controller/processor of a network entity (e.g., the controller/processor 240 of the base station 110), the controller/processor 280 of the UE 120, and/or any other component(s) of FIG. 2 may perform one or more techniques associated with collecting data for training machine learning models for channel estimation or reference signal configuration, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving a configuration for a reference signal used for data collection and/or a first message that indicates that data collection based on the reference signal is allowed; means for receiving the reference signal; means for collecting data based at least in part on the reference signal; and/or means for transmitting the data that is collected. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for transmitting a configuration for a reference signal used for data collection and/or a first message that indicates that data collection based on the reference signal is allowed; and/or means for transmitting the reference signal. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

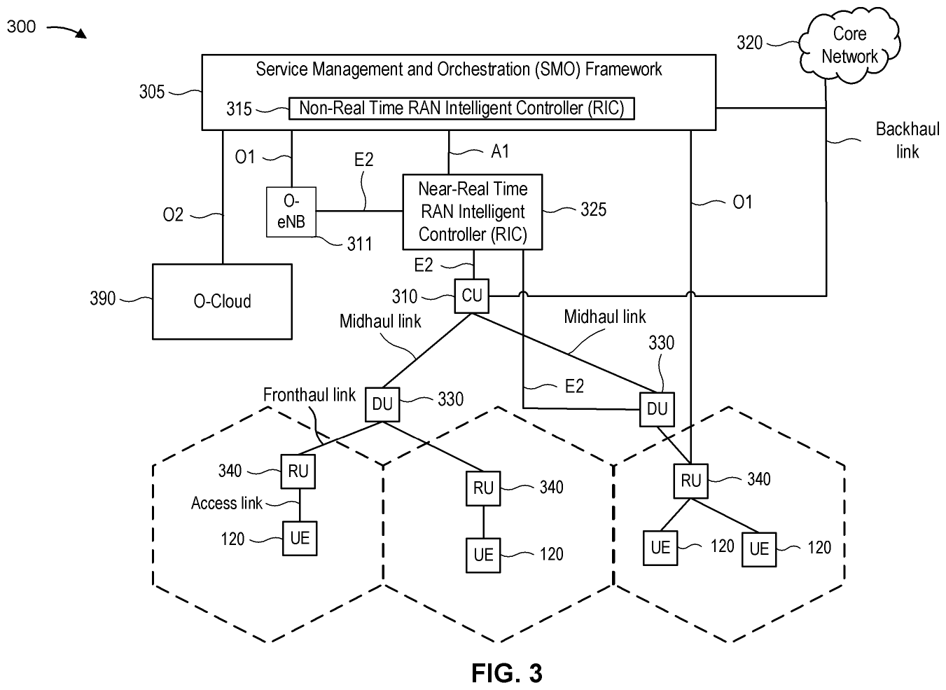

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)).

Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUS (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units.

Additionally, the units can include a wireless interface, which may include a receiver, a transmitter or transceiver (such as an RF transceiver), configured to receive or transmit signals, or both, over a wireless transmission medium to one or more of the other units. In some aspects, the CU 310 may host one or more higher layer control

functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating examples 400, 410, and 420 of channel state information (CSI) reference signal (CSI-RS) beam management procedures, in accordance with the present disclosure. As shown in FIG. 4, examples 400, 410, and 420 include a UE 120 in communication with a base station 110 in a wireless network (e.g., wireless network 100). However, the devices shown in FIG. 4 are provided as examples, and the wireless network may support communication and beam management between other devices (e.g., between a UE 120 and a base station 110 or transmit receive point (TRP), between a mobile termination node and a control node, between an integrated access and backhaul (IAB) child node and an IAB parent node, and/or between a scheduled node and a scheduling node). In some aspects, the UE 120 and the base station 110 may be in a connected state (e.g., an RRC connected state).

As shown in FIG. 4, example 400 may include a base station 110 and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the base station 110 to the UE 120. The CSI-RSs may be configured to be periodic (e.g., using RRC signaling), semi-persistent (e.g., using media access control (MAC) control element (MAC CE) signaling), and/or aperiodic (e.g., using downlink control information (DCI)).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 400 has been described in connection with CSI-RSs, the first beam management process may also use synchronization signal blocks (SSBs) for beam management in a similar manner as described above.

As shown in FIG. 4, example 410 may include a base station 110 and a UE 120 communicating to perform beam management using CSI-RSs. Example 410 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 4 and example 410, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

The UE 120 may provide CSI feedback in a codebook, which is used as a precoding matrix indicator (PMI) dictionary from which the UE 120 can report the best PMI codewords. The UE 120 may use a sequence of bits to report the PMI. Machine learning (e.g., artificial intelligence (AI)) may be used to generate CSI feedback, and a CSI encoder and/or a CSI decoder may replace the codebook with the machine learning based CSI feedback. The CSI encoder may be analogous to a PMI searching algorithm, and the CSI decoder may be analogous to the PMI codebook that is used to translate the CSI reporting bits to a PMI codeword.

The CSI encoder may have as input, and the CSI decoder may output, a downlink channel matrix (H), a transmit covariance matrix, downlink precoders (V), an interference covariance matrix (Rnn), and/or a raw vs. whitened downlink channel.

For channel estimation based on optimized CSI-RSs, N ports may be multiplexed on N resource elements (REs) in a time division multiplexing (TDM), a code division multiplexing (CDM), and/or a frequency division multiplexing (FDM) manner for each resource block (RB). The RB density may be 1 or 0.5 (transmitted on every two RBs). With AI-based CSI-RS optimization, the N ports may be multiplexed on L REs, where L is less than N. The RB density can decrease below 0.5 and non-uniform RB patterns may be considered. A UE may use an AI-based channel estimation module to perform channel estimation. Base station 110 may use an AI-based CSI-RS transmitter to multiplex the N ports on L REs inside each RB. In both cases, channels are used for training. Machine learning models may be trained via generated synthesis data or data collected over-the-air (OTA). Real-world collected data involves radio frequency (RF) impacts and is preferred. The network entity (e.g., gNB) may transmit a CSI-RS with full density, and the UE may perform channel estimation and upload the data as ground-truth for CSI feedback or for CSI-RS optimization and channel estimation.

However, it has not been specified how a reference signal is configured for this data collection or how the data collection is triggered or activated.

As indicated above, FIG. 4 is provided as an example of beam management procedures. Other examples of beam management procedures may differ from what is described with respect to FIG. 4. For example, the UE 120 and the base station 110 may perform the third beam management procedure before performing the second beam management procedure, and/or the UE 120 and the base station 110 may perform a similar beam management procedure to select a UE transmit beam.

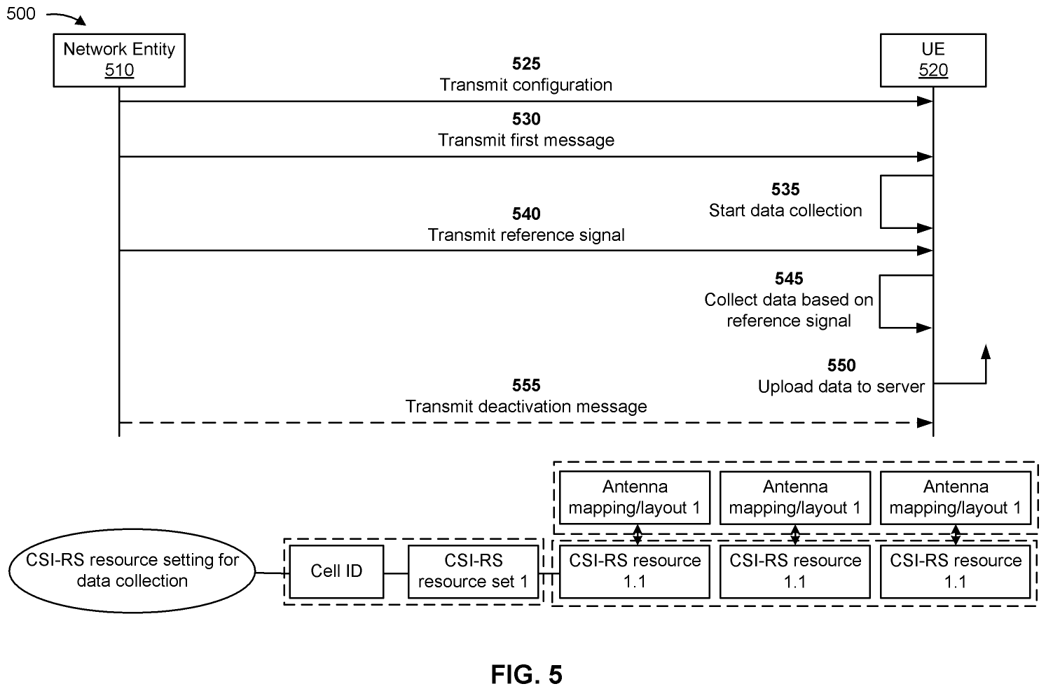

FIG. 5 is a diagram illustrating an example 500 associated with collecting data for training machine learning models, in accordance with the present disclosure. As shown in FIG. 5, a network entity 510 (e.g., base station 110) and a UE 520 (e.g., a UE 120) may communicate with one another on a wireless network (e.g., wireless network 100).

According to various aspects described herein, a UE may collect data for training machine learning models based on a trigger or activation command that indicates that data collection is allowed (the UE determines when to start) or that indicates that data collection is to start (the UE is instructed to start). A reference signal dedicated for data collection may also trigger data collection. Data collection may also start based on information in a CSI report message (e.g., trigger, activation command) or a change in a CSI reporting mode. Data collection may also be deactivated by another message that indicates that data collection is no longer allowed. By specifying when data collection starts, the UE and the network may more efficiently use real world data for training machine learning models without interfering with other operations of the UE.

Example 500 shows configuration and activation of a reference signal for data collection. In some aspects, as shown by reference number 525, the network entity 510 may transmit a configuration for the reference signal used for data collection via a MAC CE, downlink control information (DCI), or an RRC message (e.g., CSI-RS-ResourceConfigDataCollection). The configuration may indicate reference signals dedicated for data collection. The configuration may include or specify a cell or carrier identifier (ID) and/or a list of resources or reference signals (e.g., CSI-RS), where each resource is indicated by an ID or tag. The UE 520 may receive the reference resource per the resource ID and cell ID and then perform measurements. The UE 520 may also attach the resource ID and cell or carrier ID when uploading the data to a data server for training machine learning models. As shown by example 500, each resource may correspond to a particular antenna mapping or layout. The configuration may include a data collection ID, or metadata ID. The metadata ID may include beam information associated with transmitting the reference signal and/or an antenna configuration associated with transmitting the reference signal. The configuration may also include a frequency bandwidth and a time domain type. The time domain type may be periodic (with periodicity and slot offset), semi-persistent (with periodicity and slot offset), or aperiodic. The configuration may include a reference signal pattern and/or density. The configuration also may include quasi-co-location (QCL) information and/or bandwidth part (BWP) information.

In some aspects, the reference signal may be an existing reference signal but the RRC message may be new. For example, the new RRC field may be dedicated for CSI-RS-ResouceConfigDataCollection and may include a CSI-RS resource configuration ID, a cell or carrier ID, a BWP ID, a resource mapping configuration, and/or a metadata ID. In some aspects, an RRC field may be added to CSI-RS indication signaling. For example, the non-zero power (NZP)-CSI-RS-ResourceSet information element (IE) may add a data collection process ID or metadata ID. In some aspects, the network entity 510 may define a new type of reference signal for training reference signals (with a new resource mapping pattern different from existing reference signal) or a new ZP-CSI-RS pattern to rate match the reference signal (with aspects described above).

As shown by reference number 530, the network entity 510 may transmit a first message. The network entity 510 may transmit the first message via a MAC CE or DCI. The first message may be a trigger or an activation message that indicates that data collection based on the reference signal is allowed. In some aspects, if the reference signal is a dedicated reference signal for data collection, the first message may be a trigger or activation of the reference signal, and the UE 520 may start the data collection.

As shown by reference number 535, in response to receiving the activation message (e.g., for a dedicated reference signal) for data collection, the UE 520 can start data collection. In some aspects, if the configured dedicated reference signal for data collection is periodic, the RRC message configuring the reference signal for data collection may activate the periodic reference signal and the data collection. In some aspects, if the configured dedicated reference signal for data collection is semi-persistent, a MAC CE may activate and deactivate the semi-persistent reference signal, and the MAC CE may activate and deactivate the data collection based at least in part on the dedicated semi-persistent reference signal. In some aspects, the network entity 510 may use a new field in DCI (e.g., uplink DCI, downlink DCI, or a group-common DCI) to trigger the data collection based at least in part on the dedicated reference signal for data collection. A group-common DCI may include a list of reference signal IDs (e.g., TrainingRS-ID or CSI-RS-ResourceDataCollection-ID) to trigger the data collection process for a group of UEs altogether. Individual UEs may be configured (via RRC) as to which field to read from the list, or which data collection reference signal is triggered for the respective UE. Once these reference signals are activated, data collection may be activated because the reference signals may be dedicated for data collection.

As shown by reference number 540, the network entity 510 may transmit the reference signal. In some aspects, the UE 520 may detect that the reference signal is a dedicated reference signal that is configured for data collection and may start the data collection. The configuration may help the UE 520 to identify or detect a dedicated reference signal. The UE 520 may rate match, or allocate modulated bits to resources, around the dedicated reference signal for data collection.

As shown by reference number 545, the UE 520 may collect data when allowed to collect data. This may include obtaining channel measurements of the reference signal. As shown by reference number 550, the UE 520 may upload the data to a data server for use in training machine learning models for channel estimation or for configuring the reference signal or other reference signals. The data server may be a UE server that communicates with network entities (e.g., model repository).

In some aspects, as shown by reference number 555, the network entity 510 may transmit a deactivation message that indicates that data collection is no longer allowed. The UE 520 may stop collecting data. The UE 520 may transmit the collected data before or after receiving the deactivation message.

As indicated above, FIG. 5 is provided as an example. Other examples may differ from what is described with respect to FIG. 5.

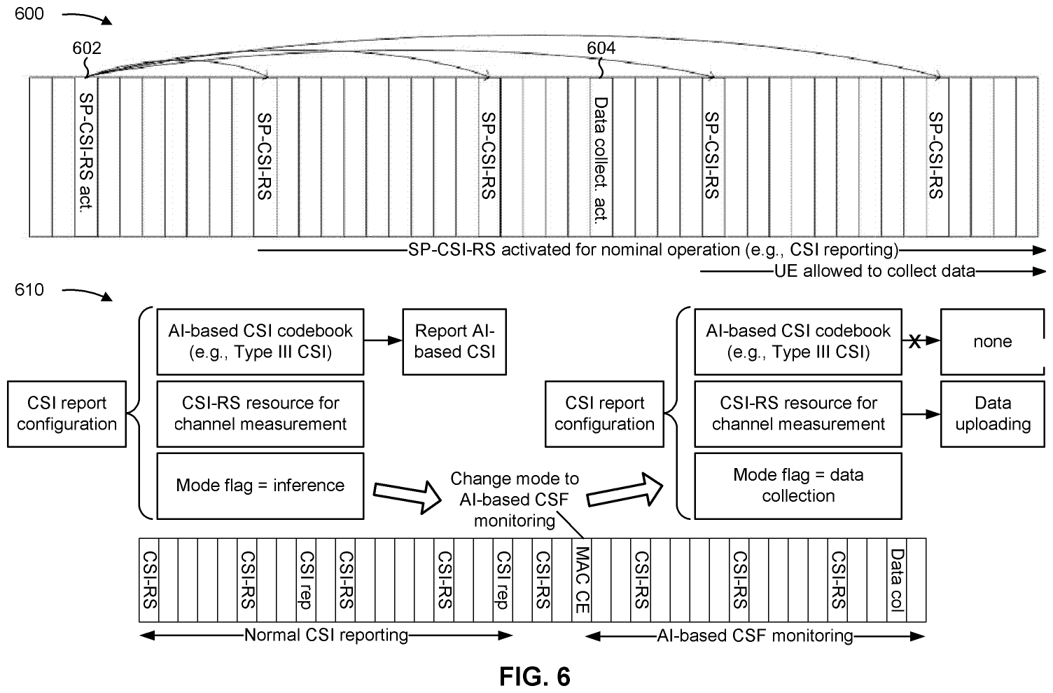

FIG. 6 is a diagram illustrating an example 600 of collecting data for training machine learning models, in accordance with the present disclosure.

In some aspects, data collection may be based on non-dedicated reference signals, and a data collection trigger or activation message (e.g., MAC CE, DCI) may trigger or activate data collection based on these reference signals. Example 600 shows an activation message 602 for semi-persistent (SP) CSI-RSs. The CSI-RSs may be used for normal CSI reporting. Example 600 also shows a data collection activation message 604 (e.g., MAC CE) that indicates that data collection, based on already activated semi-persistent CSI-RSs, by the UE 520 is allowed. The activation message 604 may include a cell or carrier ID of a reference signal resource (e.g., CSI-RS resource) and/or associated reference signal resources (e.g., CSI-RS) or resource set for data collection (indicated by resource or resource set IDs). Each resource may correspond to a particular antenna mapping or layout (implicit correspondence). The UE 520 may collect data from the CSI-RSs. The data collection may be configured and/or the collected data may be formatted for machine learning purposes. The activation message 604 may include a metadata ID. The metadata ID may include beam information associated with transmitting the reference signal and/or an antenna configuration associated with transmitting the reference signal.

In some aspects, if a reference signal is not activated yet, the reference signal may be activated or deactivated together with the data collection procedure (same MAC CE). If a reference signal is already activated for other purposes, such as for CSI reporting, the UE 520 may stop the current process and start collecting data for training machine learning models. In some aspects, if a reference signal is already used for data collection, the UE may stop the data collection if an aperiodic CSI report is triggered and this reference signal is used as a measurement resource.

In some aspects, the activation message 604 may include a bit to toggle activation or deactivation (suspension) of data collection based on the respective reference signal associated with the activation message 604. The network entity 510 may change the antenna mapping and may indicate that the UE 520 suspend reference signal measurements for data collection. For suspension, the UE 520 may refrain from collecting data for a specified time.

In some aspects, to trigger or activate the data collection based on a reference signal, the network entity 510 may transmit a group-common DCI that includes multiple segmentations. The group common DCI may trigger the data collection for a group of UEs altogether. Each segmentation may include one or more triplets, where each triplet includes at least one of a cell or carrier ID, a metadata ID, or a resource or resource set ID. In some aspects, the group-common DCI may include lists of segmentations, include a list of cell or carrier IDs, a list of metadata IDs, and a list of resource or resource set IDs. Each entry in the list may have a one-to-one-to-one mapping (cell or carrier ID to metadata ID to resource or resource set ID) across the lists. In some aspects, each segmentation of the group-common DCI may include a data collection request that activates a trigger state from a preconfigured (via RRC) trigger state list. Each trigger state may have multiple triplets, where each triplet includes a cell or carrier ID, a metadata ID, and/or a resource or resource set ID.

If the DCI is a group-common DCI, an individual UE (e.g., UE 520) may receive an indication (via RRC) of which segmentation in the DCI the UE 520 is to read. This may include which triplets to read, which components in the lists to read, or which requests to read. The UE 520 may determine the triplets, components, and/or requests by a starting bit or field to read and a length of a bit or field to read. This means that each UE will know which reference signal resource(s), their carrier or cell IDs, and their metadata IDs to be used for data collection.

In some aspects, for the group-common DCI methods, the UE 520 may be activated for data collection if the DCI is scrambled by a first sequence, such as a data collection activation radio network temporary identifier (RNTI). The UE 520 may be deactivated for data collection if the DCI is scrambled by a second sequence, such as a data collection deactivation RNTI. In some aspects, the group-common DCI is scrambled by a data collection RNTI, and a bit or DCI codepoints may be used to indicate activation or deactivation of the data collection in each segmentation.

In some aspects, UE-specific DCI may be used to activate or deactivate data collection. With UE-specific downlink or uplink DCI, each UE may be provided with a single triplet or a single request. The UE-specific DCI may include multiple segmentations. Each segmentation may include one or more triplets, where each triplet includes at least one of a cell or carrier ID, a metadata ID, or a resource or resource set ID. In some aspects, the UE-specific DCI may include lists of segmentations, include a list of cell or carrier IDs, a list of metadata IDs, and a list of resource or resource set

IDs. Each entry in the list may have a one-to-one-to-one mapping across the lists. In some aspects, each segmentation may include a data collection request that activates a trigger state from a preconfigured trigger state list. Each trigger state may have multiple triplets, where each triplet includes a cell or carrier ID, a metadata ID, and/or a resource or resource set ID. For either group-common DCI or UE-specific DCI, if an aperiodic reference signal is used, the aperiodic reference signal may be triggered using the DCI or other message.

In some aspects, a configuration configuring reference signal resources for data collection may configure a dedicated report (e.g., CSI report) for data collection. This may include, for example, setting a report quantity “none” or “data-collection” (but without Layer 1 report). This means that the CSI-RS resource associated in this CSI report is used for data collection.

In some aspects, as shown by example 610, the configuration may include a bit or a mode flag that indicates that the CSI report is set to a data collection mode. Once in the data collection mode, the CSI-RS resource associated with this CSI report is used for data collection. A trigger or activation message may trigger a CSI report that is dedicated for data collection or a CSI report that is for a data collection mode. The message may indicate that a CSI feedback (CSF) mode is changed from a normal CSI report to data collection, or to both CSI reporting and data collection. The mode change can be via DCI or a MAC CE. If the UE 520 determine that a reference signal for the CSI report is for data collection, the UE 520 may determine when to upload data.

For a CSI report, central process unit (CPU) counting may involve one CPU per resource. Active resource counting may involve one CPU per resource. In some aspects, a mode flag may be included in a legacy report (e.g., CSI report) configuration for dynamically changing the report quantity.

In some aspects, the data collection may occupy one CPU per resource from the beginning of data collection activation command to its release. For active resources or ports, the data collection may occupy one active resource per resource and occupy P active ports, where P is the quantity of ports per resource for data collection. Counting may start from the beginning of data collection activation command to its release. The UE 520 may report a UE capability for resource usage. The UE 520 may report, per band or per band combination (BC), a list of quantity of ports per resource, maximum quantity of resources, and/or a maximum quantity of total ports, and report that the UE 520 is able to handle data collection. The UE 520 may further report the quantities for the simultaneous processing of data collection with other CSI (per band and per BC reporting). An alternative approach for the active resource and capability reporting may include the UE 520 reporting a capability of processing. This may include up to N resources and P total ports for data collection per slot, a quantity of configured resources and ports that should honor this capability, and/or a quantity of data collection processes.

If the UE 520 uses reference signals for data collection, a long periodicity leads to inefficient data collection and a short periodicity leads to more data. The UE 520 may not be able to handle all the data collection frequently and this may be a waste of reference signal overhead. In some aspects, the configuration may specify a periodicity of reference signals for data collection. The UE 520 may report a UE capability for supporting data collection, including a supported periodicity. The network entity 510 may configure the periodicity of the reference signals based at least in part on the UE capability. In some aspects, it may be up to the UE 520 as to when or in which reference signal occasions to perform data collection. It may be up to the UE 520 as to when collected data (e.g., measured data) is uploaded.

When the network entity 510 configures the reference signals, the network entity 510 may honor the UE capability (i.e., not configure any periodicity smaller than the periodicity indicated by the UE 520). For example, if the UE 520 reports a capability to handle a reference signal periodicity of 10 milliseconds (ms), the network entity 510 may configure reference signals with a periodicity greater than 10 ms.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120, UE 520) performs operations associated with reference signal data collection for training machine learning models.

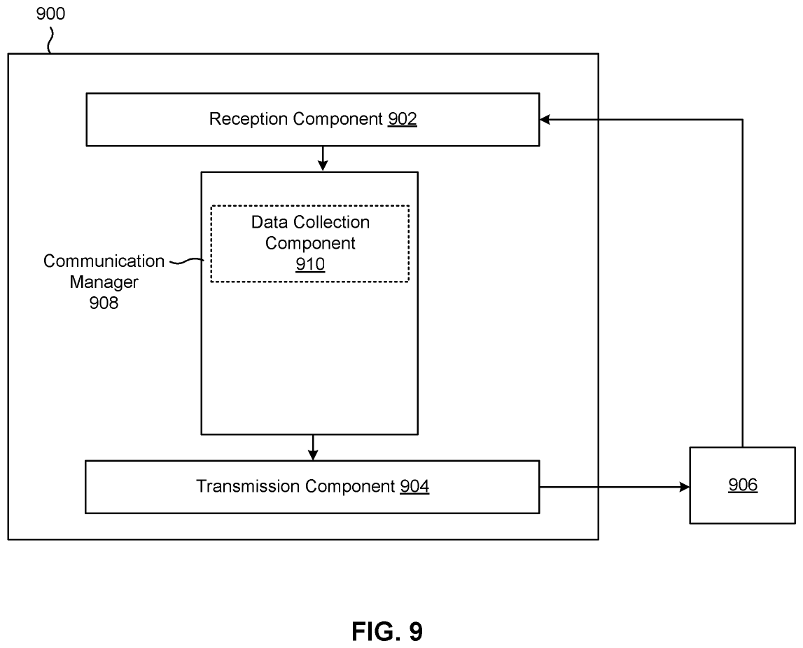

As shown in FIG. 7, in some aspects, process 700 may include receiving a configuration for a reference signal used for data collection and/or a first message that indicates that data collection based on the reference signal is allowed (block 710). For example, the UE (e.g., using communication manager 908 and/or reception component 902 depicted in FIG. 9) may receive a configuration for a reference signal used for data collection and/or a first message that indicates that data collection based on the reference signal is allowed, as described above.

As further shown in FIG. 7, in some aspects, process 700 may include receiving the reference signal (block 720). For example, the UE (e.g., using communication manager 908 and/or reception component 902 depicted in FIG. 9) may receive the reference signal, as described above.

As further shown in FIG. 7, in some aspects, process 700 may include collecting data based at least in part on the reference signal (block 730). For example, the UE (e.g., using communication manager 908 and/or data collection component 910 depicted in FIG. 9) may collect data based at least in part on the reference signal, as described above.

As further shown in FIG. 7, in some aspects, process 700 may include transmitting the data that is collected (block 740). For example, the UE (e.g., using communication manager 908 and/or transmission component 904 depicted in FIG. 9) may transmit the data that is collected, as described above.

Process 700 may include additional aspects, such as any single aspect or any combination of aspects described below and/or in connection with one or more other processes described elsewhere herein.

In a first aspect, process 700 includes receiving a second message that indicates that data collection is not allowed, and stopping data collection based at least in part on the second message.

In a second aspect, alone or in combination with the first aspect, collecting the data includes collecting channel measurements based on the reference signal.

In a third aspect, alone or in combination with one or more of the first and second aspects, the data is associated with machine learning for channel estimation or configuring reference signals.

In a fourth aspect, alone or in combination with one or more of the first through third aspects, the configuration specifies that the reference signal is a dedicated reference signal for data collection, and collecting the data includes collecting the data in response to the reference signal being a dedicated reference signal.

In a fifth aspect, alone or in combination with one or more of the first through fourth aspects, the first message activates the dedicated reference signal.

In a sixth aspect, alone or in combination with one or more of the first through fifth aspects, the configuration specifies one or more of a cell or carrier ID, one or more reference resource IDs, a metadata ID, or a resource mapping configuration for the reference resource IDs.

In a seventh aspect, alone or in combination with one or more of the first through sixth aspects, the metadata ID includes one or more of beam information associated with transmitting the reference signal or an antenna configuration associated with transmitting the reference signal.

In an eighth aspect, alone or in combination with one or more of the first through seventh aspects, receiving the first message includes receiving the first message in a MAC CE or DCI.

In a ninth aspect, alone or in combination with one or more of the first through eighth aspects, the MAC CE includes one or more of a cell or carrier ID, an associated reference resource ID, a metadata ID, or a bit that indicates whether the MAC CE is for activation or deactivation.

In a tenth aspect, alone or in combination with one or more of the first through ninth aspects, the DCI includes one or more triplets that each include one or more of a cell or carrier ID, a metadata ID, or a resource or resource set ID.

In an eleventh aspect, alone or in combination with one or more of the first through tenth aspects, the DCI includes one or more of a list of cell or carrier IDs, a list of metadata IDs, or a list of resource or resource set IDs, and there is a one-to-one-to-one mapping among entries across the lists.

In a twelfth aspect, alone or in combination with one or more of the first through eleventh aspects, the DCI includes a list of trigger states with each trigger state including multiple triplets, with each triplet including a cell or carrier ID, a metadata ID, and a resource or resource set ID.

In a thirteenth aspect, alone or in combination with one or more of the first through twelfth aspects, the DCI is activation DCI that is scrambled with a data collection activation RNTI.

In a fourteenth aspect, alone or in combination with one or more of the first through thirteenth aspects, process 700 includes receiving deactivation DCI that is scrambled with a data collection deactivation RNTI, and stopping the collecting of the data in response to the deactivation DCI.

In a fifteenth aspect, alone or in combination with one or more of the first through fourteenth aspects, the DCI is a group-common DCI, and process 700 includes receiving a radio resource control message that indicates which triplet, which entry of a list, or which trigger state is used to indicate activation or deactivation of the collecting of the data.

In a sixteenth aspect, alone or in combination with one or more of the first through fifteenth aspects, the DCI is a group-common DCI, and activation or deactivation of the collecting of the data is indicated by a bit in each segmentation.

In a seventeenth aspect, alone or in combination with one or more of the first through sixteenth aspects, the configuration specifies a CSI report that is dedicated to data collection, and process 700 includes determining that a reference signal for the CSI report is for data collection.

In an eighteenth aspect, alone or in combination with one or more of the first through seventeenth aspects, the configuration specifies a CSI report and includes a bit or flag that indicates that the CSI report is set to data collection mode, and process 700 includes determining that a reference signal for the CSI report is for data collection.

In a nineteenth aspect, alone or in combination with one or more of the first through eighteenth aspects, the first message activates or triggers a CSI report dedicated for data collection or a CSI report that is for a data collection mode.

In a twentieth aspect, alone or in combination with one or more of the first through nineteenth aspects, the first message indicates that a CSI feedback mode is changed to a nominal CSI report, data collection, or both.

In a twenty-first aspect, alone or in combination with one or more of the first through twentieth aspects, process 700 includes occupying at least one processing unit per reference signal resource for the collecting of the data.

In a twenty-second aspect, alone or in combination with one or more of the first through twenty-first aspects, the collecting of the data occupies one or more of a quantity of ports per reference signal resource, a quantity of reference signal resources, a quantity of total ports, or a combination thereof.

In a twenty-third aspect, alone or in combination with one or more of the first through twenty-second aspects, process 700 includes transmitting a UE capability for supporting data collection, and the UE capability specifies support for one or more of a periodicity of a data collection reference signal, a quantity of ports per resource, a maximum quantity of resources, a maximum quantity of total ports, a quantity of processing units, or a quantity of data collection processes.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network entity, in accordance with the present disclosure. Example process 800 is an example where the network entity (e.g., network entity 510) performs operations associated with configuring reference signal data collection for training machine learning models.

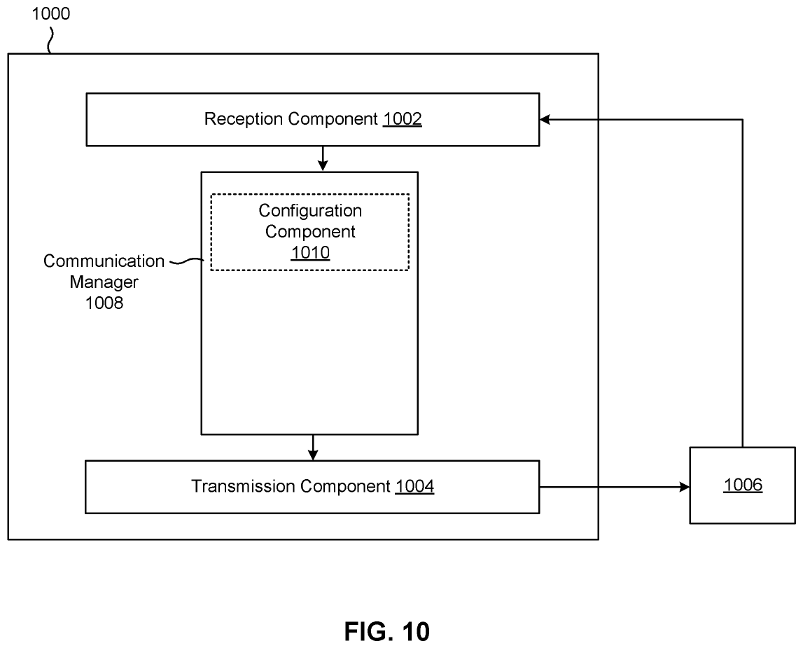

As shown in FIG. 8, in some aspects, process 800 may include transmitting a configuration for a reference signal used for data collection and/or a first message that indicates that data collection based on the reference signal is allowed (block 810). For example, the network entity (e.g., using communication manager 1008 and/or transmission component 1004 depicted in FIG. 10) may transmit a configuration for a reference signal used for data collection and/or a first message that indicates that data collection based on the reference signal is allowed, as described above.

As further shown in FIG. 8, in some aspects, process 800 may include transmitting the reference signal (block 820). For example, the network entity (e.g., using communication manager 1008 and/or transmission component 1004 depicted in FIG. 10) may transmit the reference signal, as described above.

Process 800 may include additional aspects, such as any single aspect or any combination of aspects described below and/or in connection with one or more other processes described elsewhere herein.

In a first aspect, process 800 includes using the data to train machine learning models for channel estimation or reference signal configuration.

In a second aspect, alone or in combination with the first aspect, process 800 includes transmitting a second message that indicates that data collection is not allowed.

In a third aspect, alone or in combination with one or more of the first and second aspects, the configuration specifies that the reference signal is a dedicated reference signal for data collection.

In a fourth aspect, alone or in combination with one or more of the first through third aspects, the configuration specifies one or more of a cell or carrier ID, one or more reference resource IDs, a metadata ID, or a resource mapping configuration for the reference resource IDs.

In a fifth aspect, alone or in combination with one or more of the first through fourth aspects, process 800 includes receiving an indication of a UE capability for supporting data collection, and the configuration is based at least in part on the UE capability.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE (e.g., a UE 120, UE 520), or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 908. The communication manager 908 may control and/or otherwise manage one or more operations of the reception component 902 and/or the transmission component 904. In some aspects, the communication manager 908 may include one or more antennas, a modem, a controller/processor, a memory, or a combination thereof, of the UE described in connection with FIG. 2. The communication manager 908 may be, or be similar to, the communication manager 140 depicted in FIGS. 1 and 2. For example, in some aspects, the communication manager 908 may be configured to perform one or more of the functions described as being performed by the communication manager 140. In some aspects, the communication manager 908 may include the reception component 902 and/or the transmission component 904. In some aspects, the communication manager 908 may include the reception component 902 and/or the transmission component 904. The communication manager 908 may include a data collection component 910, among other examples.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive a configuration for a reference signal used for data collection and/or a first message that indicates that data collection based on the reference signal is allowed. The reception component 902 may receive the reference signal. The data collection component 910 may collect data based at least in part on the reference signal. The transmission component 904 may transmit the data that is collected.

The reception component 902 may receive a second message that indicates that data collection is not allowed. The data collection component 910 may stop data collection based at least in part on the second message.

The reception component 902 may receive deactivation DCI that is scrambled with a data collection deactivation RNTI. The data collection component 910 may stop the collecting of the data in response to the deactivation DCI. The data collection component 910 may occupy at least one processing unit per reference signal resource for the collecting of the data.

The transmission component 904 may transmit a UE capability for supporting data collection, where the UE capability specifies support for one or more of a periodicity of a data collection reference signal, a quantity of ports per resource, a maximum quantity of resources, a maximum quantity of total ports, a quantity of processing units, or a quantity of data collection processes.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network entity (e.g., base station 110, network entity 510), or a network entity may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 1008. The communication manager 1008 may control and/or otherwise manage one or more operations of the reception component 1002 and/or the transmission component 1004. In some aspects, the communication manager 1008 may include one or more antennas, a modem, a controller/processor, a memory, or a combination thereof, of the network entity described in connection with FIG. 2. The communication manager 1008 may be, or be similar to, the communication manager 150 depicted in FIGS. 1 and 2. For example, in some aspects, the communication manager 1008 may be configured to perform one or more of the functions described as being performed by the communication manager 150. In some aspects, the communication manager 1008 may include the reception component 1002 and/or the transmission component 1004. The communication manager 1008 may include a configuration component 1010, among other examples.

In some aspects, the apparatus 1000 may be configured to perform one or more operations described herein in connection with FIGS. 1-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network entity described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network entity described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network entity described in connection with FIG. 2. In some aspects, the transmission component 1004 may be co-located with the reception component 1002 in a transceiver.

The transmission component 1004 may transmit a configuration for a reference signal used for data collection and/or a first message that indicates that data collection based on the reference signal is allowed. The configuration component 1010 may generate the configuration based on a UE capability, channel conditions, and/or traffic conditions. The transmission component 1004 may transmit the reference signal.

The transmission component 1004 may transmit a second message that indicates that data collection is not allowed. The reception component 1002 may receive an indication of a UE capability for supporting data collection, and the configuration may be based at least in part on the UE capability.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving one or more of a configuration for a reference signal used for data collection or a first message that indicates that data collection based on the reference signal is allowed; receiving the reference signal; collecting data based at least in part on the reference signal; and transmitting the data that is collected.

Aspect 2: The method of Aspect 1, further comprising: receiving a second message that indicates that data collection is not allowed; and stopping data collection based at least in part on the second message.

Aspect 3: The method of Aspect 1 or 2, wherein collecting the data includes collecting channel measurements based on the reference signal.

Aspect 4: The method of any of Aspects 1-3, wherein the data is associated with machine learning for channel estimation or configuring reference signals.

Aspect 5: The method of any of Aspects 1-4, wherein the configuration specifies that the reference signal is a dedicated reference signal for data collection, and wherein collecting the data includes collecting the data in response to the reference signal being a dedicated reference signal.

Aspect 6: The method of Aspect 5, wherein the first message activates the dedicated reference signal.

Aspect 7: The method of any of Aspects 1-6, wherein the configuration specifies one or more of a cell or carrier identifier (ID), one or more reference resource IDs, a metadata ID, or a resource mapping configuration for the reference resource IDs.

Aspect 8: The method of Aspect 7, wherein the metadata ID includes one or more of beam information associated with transmitting the reference signal or an antenna configuration associated with transmitting the reference signal.

Aspect 9: The method of any of Aspects 1-8, wherein receiving the first message includes receiving the first message in a medium access control control element (MAC CE) or downlink control information (DCI).

Aspect 10: The method of Aspect 9, wherein the MAC CE includes one or more of a cell or carrier identifier (ID), an associated reference resource ID, a metadata ID, or a bit that indicates whether the MAC CE is for activation or deactivation.

Aspect 11: The method of Aspect 9, wherein the DCI includes one or more triplets that each include one or more of a cell or carrier ID, a metadata ID, a resource or resource set ID.

Aspect 12: The method of Aspect 9, wherein the DCI includes one or more of a list of cell or carrier IDs, a list of metadata IDs, or a list of resource or resource set IDs, and wherein there is a one-to-one-to-one mapping among entries across the lists.

Aspect 13: The method of Aspect 9, wherein the DCI includes a list of trigger states with each trigger state including multiple triplets, with each triplet including a cell or carrier identifier (ID), a metadata ID, and a resource or resource set ID.

Aspect 14: The method of Aspect 9, wherein the DCI is activation DCI that is scrambled with a data collection activation radio network temporary identifier (RNTI).

Aspect 15: The method of Aspect 14, further comprising: receiving deactivation DCI that is scrambled with a data collection deactivation RNTI; and stopping the collecting of the data in response to the deactivation DCI.

Aspect 16: The method of Aspect 9, wherein the DCI is a group-common DCI, and wherein the method includes receiving a radio resource control message that indicates which triplet, which entry of a list, or which trigger state is used to indicate activation or deactivation of the collecting of the data.

Aspect 17: The method of Aspect 9, wherein the DCI is a group-common DCI, and wherein activation or deactivation of the collecting of the data is indicated by a bit in each segmentation.

Aspect 18: The method of any of Aspects 1-17, wherein the configuration specifies a channel state information (CSI) report that is dedicated to data collection, and wherein the method includes determining that a reference signal for the CSI report is for data collection.

Aspect 19: The method of any of Aspects 1-18, wherein the configuration specifies a channel state information (CSI) report and includes a bit or flag that indicates that the CSI report is set to data collection mode, and wherein the method includes determining that a reference signal for the CSI report is for data collection.

Aspect 20: The method of any of Aspects 1-19, wherein the first message activates or triggers a channel state information (CSI) report dedicated for data collection or a CSI report that is for a data collection mode.

Aspect 21: The method of any of Aspects 1-20, wherein the first message indicates that a channel state information (CSI) feedback mode is changed to a nominal CSI report, data collection, or both.

Aspect 22: The method of any of Aspects 1-21, further comprising occupying at least one processing unit per reference signal resource for the collecting of the data.

Aspect 23: The method of any of Aspects 1-22, wherein the collecting of the data occupies one or more of a quantity of ports per reference signal resource, a quantity of reference signal resources, a quantity of total ports, or a combination thereof.

Aspect 24: The method of any of Aspects 1-23, further comprising transmitting a UE capability for supporting data collection, wherein the UE capability specifies support for one or more of a periodicity of a data collection reference signal, a quantity of ports per resource, a maximum quantity of resources, a maximum quantity of total ports, a quantity of processing units, or a quantity of data collection processes.

Aspect 25: A method of wireless communication performed by a network entity, comprising: transmitting one or more of a configuration for a reference signal used for data collection or a first message that indicates that data collection based on the reference signal is allowed; transmitting the reference signal; and receiving data that is collected based at least in part on the reference signal.

Aspect 26: The method of Aspect 25, further comprising using the data to train machine learning models for channel estimation or reference signal configuration.

Aspect 27: The method of Aspect 25 or 26, further comprising transmitting a second message that indicates that data collection is not allowed.

Aspect 28: The method of any of Aspects 25-27, wherein the configuration specifies that the reference signal is a dedicated reference signal for data collection.

Aspect 29: The method of any of Aspects 25-28, wherein the configuration specifies one or more of a cell or carrier identifier (ID), one or more reference resource IDs, a metadata ID, or a resource mapping configuration for the reference resource IDs.

Aspect 30: The method of any of Aspects 25-29, further comprising receiving an indication of a UE capability for supporting data collection, and wherein the configuration is based at least in part on the UE capability.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive one or more of a configuration for a reference signal used for data collection or a first message that indicates that data collection based on the reference signal is allowed;
receive the reference signal;
collect data based at least in part on the reference signal; and
transmit the data that is collected.

2. The UE of claim 1, wherein the one or more processors are configured to:
receive a second message that indicates that data collection is not allowed; and
stop data collection based at least in part on the second message.

3. The UE of claim 1, wherein the one or more processors, to collect the data, are configured to collect channel measurements based on the reference signal.

4. The UE of claim 1, wherein the data is associated with machine learning for channel estimation or configuring reference signals.

5. The UE of claim 1, wherein the configuration specifies that the reference signal is a dedicated reference signal for data collection, and wherein the one or more processors, to collect the data, are configured to collect the data in response to the reference signal being a dedicated reference signal.

6. The UE of claim 5, wherein the first message activates the dedicated reference signal.

7. The UE of claim 1, wherein the configuration specifies one or more of a cell or carrier identifier (ID), one or more reference resource IDs, a metadata ID, or a resource mapping configuration for the reference resource IDs.

8. The UE of claim 7, wherein the metadata ID includes one or more of beam information associated with transmitting the reference signal or an antenna configuration associated with transmitting the reference signal.

9. The UE of claim 1, wherein the one or more processors, to receive the first message, are configured to receive the first message in a medium access control control element (MAC CE) or downlink control information (DCI).

10. The UE of claim 9, wherein the MAC CE includes one or more of a cell or carrier identifier (ID), an associated reference resource ID, a metadata ID, or a bit that indicates whether the MAC CE is for activation or deactivation.

11. The UE of claim 9, wherein the DCI includes one or more triplets that each include one or more of a cell or carrier ID, a metadata ID, or a resource or resource set ID.

12. The UE of claim 9, wherein the DCI includes one or more of a list of cell or carrier IDs, a list of metadata IDs, or a list of resource or resource set IDs, and wherein there is a one-to-one-to-one mapping among entries across the lists.

13. The UE of claim 9, wherein the DCI includes a list of trigger states with each trigger state including multiple triplets, with each triplet including a cell or carrier identifier (ID), a metadata ID, and a resource or resource set ID.

14. The UE of claim 9, wherein the DCI is activation DCI that is scrambled with a data collection activation radio network temporary identifier (RNTI).

15. The UE of claim 14, wherein the one or more processors are configured to:
receive deactivation DCI that is scrambled with a data collection deactivation RNTI; and
stop the collecting of the data in response to the deactivation DCI.

16. The UE of claim 9, wherein the DCI is a group-common DCI, and wherein the one or more processors are configured to receive a radio resource control message that indicates which triplet, which entry of a list, or which trigger state is used to indicate activation or deactivation of the collecting of the data.

17. The UE of claim 9, wherein the DCI is a group-common DCI, and wherein activation or deactivation of the collecting of the data is indicated by a bit in each segmentation.

18. The UE of claim 1, wherein the configuration specifies a channel state information (CSI) report that is dedicated to data collection, and wherein the one or more processors are configured to determine that a reference signal for the CSI report is for data collection.

19. The UE of claim 1, wherein the configuration specifies a channel state information (CSI) report and includes a bit or flag that indicates that the CSI report is set to data collection mode, and wherein the one or more processors are configured to determine that a reference signal for the CSI report is for data collection.

20. The UE of claim 1, wherein the first message activates or triggers a channel state information (CSI) report dedicated for data collection or a CSI report that is for a data collection mode.

21. The UE of claim 1, wherein the first message indicates that a channel state information (CSI) feedback mode is changed to a nominal CSI report, data collection, or both.

22. The UE of claim 1, wherein the one or more processors are configured to occupy at least one processing unit per reference signal resource for the collecting of the data.

23. The UE of claim 1, wherein collection of the data occupies one or more of a quantity of ports per reference signal resource, a quantity of reference signal resources, a quantity of total ports, or a combination thereof.

24. The UE of claim 1, wherein the one or more processors are configured to transmit a UE capability for supporting data collection, wherein the UE capability specifies support for one or more of a periodicity of a data collection reference signal, a quantity of ports per resource, a maximum quantity of resources, a maximum quantity of total ports, a quantity of processing units, or a quantity of data collection processes.

25. A network entity for wireless communication, comprising:
a memory; and
one or more processors, coupled to the memory, configured to:
transmit one or more of a configuration for a reference signal used for data collection or a first message that indicates that data collection based on the reference signal is allowed; and
transmit the reference signal.

26. The network entity of claim 25, wherein the one or more processors are configured to use the data to train machine learning models for channel estimation or reference signal configuration.

27. The network entity of claim 25, wherein the one or more processors are configured to transmit a second message that indicates that data collection is not allowed.

28. The network entity of claim 25, wherein the configuration specifies that the reference signal is a dedicated reference signal for data collection.

29. The network entity of claim 25, wherein the configuration specifies one or more of a cell or carrier identifier (ID), one or more reference resource IDs, a metadata ID, or a resource mapping configuration for the reference resource IDs.

30. The network entity of claim 25, wherein the one or more processors are configured to receive an indication of a UE capability for supporting data collection, and wherein the configuration is based at least in part on the UE capability.
